(19) United States
(12) Patent Application Publication
(10) Pub. No.: US 2026/0048945 A1
(43) Pub. Date: Feb. 19, 2026

(54) SEMIAUTOMATIC SPIRAL-TIGHTENING DEVICE FOR A VIBRATING CONVEYOR

(71) Applicant: KRÄMER AG, Bassersdorf (CH)

(72) Inventors: Horst FISCHER, Lauchringen (DE); Tobias FRECH, Dübendorf (CH); Mario RÜTTI, Illnau (CH)

(21) Appl. No.: 19/103,270

(22) PCT Filed: Aug. 16, 2022
(86) PCT No.: PCT/CH2022/050019

§ 371 Date: Feb. 12, 2025

(51) Int. Cl. B65G 27/02; B65G 27/08

(52) U.S. Cl. CPC B65G 27/02; B65G 27/08

(57) ABSTRACT

The present invention relates to a spiral-tightening device for a modular spiral tower (1) of a vertical vibrating conveyor (S), in which vibrating conveyor a wedge slider (4) is inserted between the drive (3) and the spiral tower (1). The wedge slider comprises an anchor plate assembly (25), which is vibratable, i.e. is coupled to a drive, and a wedge assembly (24), which is at rest, i.e. is decoupled from the drive. A wedge (12) in said wedge slider (4) can be slid by means of an electronically controlled stepper motor (18) and, in the process, loads or relaxes a spring element (13), which transfers its predetermined spring force to a tension anchor (7). Said device allows stable vibratory behavior to be ensured and comprises a controller for closed-loop control of the operation of said wedge slider (4), i.e. allows the installation and assembly, operation, and removal and disassembly of the spiral tower (1) to be semiautomatically controlled. Principally, said spiral-tightening device and the method for closed-loop control of the operation thereof are suitable for use in the case of vibrating conveyors having a conveying height of over approximately 2.5 m, in particular from approximately 2.5 m to approximately 5 m.

The present invention relates to a spiral-tightening device for a vertical vibrating conveyor according to the generic definition of claim 1, as well as a method for controlling it according to the generic definition of claim 15 and its use according to the generic definition of claim 18.

Vertical vibrating conveyors are preferably used for dedusting and/or deburring small parts, especially tablets and capsules in the pharmaceutical industry. Vibrating conveyors of this type are, for example, known from WO2021/212241 and comprise a plurality of assemblies, in particular a drive unit having an anchor plate that can be set in vibration and a spiral tower that stands vertically on said anchor plate with a helical conveyor track for transporting the small parts in an upward direction. Said spiral tower is usually configured in several pieces in the form of stackable modules, in order to be able to mount it for different delivery heights in a simple manner.

When mounting such a vibrating conveyor, the first spiral module, also referred to below as the inlet spiral, is placed on the anchor plate and fastened thereto using the first tie rod module, also referred to below as the inlet tie rod. Known inlet tie rods are connected to a tie rod of the anchor plate by means of a bayonet lock. The spiral tower is then built module by module, i.e. first another spiral module, then another tie rod module. The end is closed by means of an outlet spiral and an outlet tie rod, whereby the outlet tie rod is manually screwed to the previously mounted tie rod module using a handle, in order to clamp the entire tie rod to the anchor plate. Depending on the application, a torque of different magnitudes can be applied to adjust the tension force of the tie rod, which is important for the vibratory behavior of the spiral tower.

Unfortunately, manual clamping of the modular tie rod leads to tension forces that very in strength, or to undesirable deviations from a predefined value for the tension stress, which also causes unpredictable vibratory behavior for the same vibrating conveyor and for the same application. This not only causes variations in the processed end products, but can also damage the drive, which in turn leads to unwanted downtime, i.e. production losses. Furthermore, manual handling of tools, such as torque wrenches, is undesirable in clean rooms and, with large lifting heights, e.g. approx. 2.5 m and more, the required torque on the tie rod can no longer be easily applied by hand.

Furthermore, modern industry is endeavoring to further expand these vibrating conveyors, in particular to further increase their conveying height of approx. 2 m today in order to further extend the conveying path. This results in further problems for the person skilled in the art that cannot be solved easily. Among other things, the extension of the entire tie rod requires increased tension forces that can no longer be provided manually. In addition, manual handling of wrenches at a height of more than 2 m proves to be time-consuming and also highly risky.

It is therefore an object of the invention to create a vertical spiral tower of a vibrating conveyor which does not have the disadvantages of the known spiral towers. In particular, the aim is to create a quick and safe spiral-tightening device with a determinable vibratory behavior, in particular with a tie rod length-dependent and reproducible tension force. This should enable the construction of a controlled vibrating conveyor, avoiding the risky and time-consuming handling and inadequate clamping of the tie rod, for example at a height of approx. over 2.5 meters. In particular, it should be possible to tighten the tie rod without tools during the mounting process.

According to the invention, this object is achieved with a semiautomatic spiral-tightening device, i.e. one supported by the software, with the features of claim 1, and with a method of claim 15.

In particular, the present invention relates generally to the tool-free mounting and the adjustability of the vibratory behavior of a modularly constructed vibrating conveyor with a modular spiral tower, a modular tie rod, a vibratable drive, and a wedge slider described in more detail below.

To build a spiral tower that comprises a plurality modules, the latter is clamped together by the modular tie rods. After an inlet spiral has been fitted, an inlet tie rod is connected to a tie rod by means of a bayonet lock. The spiral tower is then mounted module by module. First a module spiral, then a module tie rod. The end is closed in the usual way using an outlet spiral and an outlet tie rod. However, when using the spiral-tightening device according to the invention, a final screw cap only needs to be screwed onto the outlet tie rod up to a defined stop on the outlet spiral, wherein only a small torque is required, which can be applied manually without any special effort.

According to the invention, the wedge slider is inserted between the drive and the spiral tower and comprises a displaceable wedge, by means of which the tie rod, which can be connected to the inlet tie rod, can be shifted vertically. Said spiral tightening device has a first assembly, also referred to below as the wedge assembly, which is uncoupled from the drive, and a second assembly, also referred to below as the anchor plate assembly, which is coupled to the drive, i.e. can vibrate. With the wedge slider according to the invention, the tie rod can be automated and tensioned to a predetermined tension. This means that the asymmetrically designed wedge assembly does not vibrate even when the vibrating conveyor is in operation, and the spiral tower has a stable vibratory behavior. Said wedge assembly essentially comprises an electronically controllable stepper motor, a displaceable wedge, a threaded nut with a threaded spindle, at least a first and a second proximity switch, as well as a slide bar and possibly a cover, wherein the wedge is displaceable along said slide bar by means of the threaded spindle. In particular, for controlling the stepper motor, the first proximity switch arranged near the mounting position of the wedge and the second proximity switch arranged near the clamping position of the wedge are electronically connected to the electronic control unit.

The anchor plate assembly forms an assembly, which is connected to a tappet carrier plate that is spaced apart and can be displaced, to which tappet carrier plate a tappet that is guided vertically displaceably in a tappet guide plate and firmly connected to the tie rod is fastened, such that said tappet, the tappet guide plate and the tappet carrier plate are coupled to the anchor plate in a vibration-transmitting manner. This assembly also vibrates when the vibrating conveyor is in operation.

To tighten the tie rod, a wedge slider with a displaceable wedge is arranged between the spiral tower and the drive. Said wedge is pushed from a mounting position into a clamping position or vice versa by means of an electronically controlled stepper motor and a threaded spindle and nut, as well as the first and second proximity switches, when clamping or releasing pressure along the slide bar.

A spring element with a predefined spring force is fitted between the tappet carrier plate and the tappet guide plate. In the clamping position, said element is tensioned in such a way that it exerts the desired clamping force on the tie rod, and in the mounting position it is compressed to such an extent that the tie rod is relaxed in the desired way. For this purpose, the wedge rests on the one hand on several support rollers which are fastened to the resting wedge assembly, and on the other hand, when the wedge is displaced, several guide rollers that are firmly connected to the tappet carrier plate rest under spring tension on a beveled surface of the wedge until the wedge is in its clamping position, i.e. no longer contacts the guide rollers coupled to the spring element. During vibrating operation, the wedge is always in the clamping position and therefore no vibrations can be transmitted to the wedge assembly, i.e. the asymmetrically constructed wedge assembly cannot influence the vibratory behavior of the spiral tower. The beveled surface of the wedge preferably has an inclination angle of 2°to 4°.

To mount or dismount the spiral tower, the displaceable wedge is transitioned from the clamping position to its mounting or dismounting position using the stepper motor. In this mounting position of the wedge, the tappet carrier plate with the tappet is offset against the given spring force of the spring element in the direction of the spiral tower, i.e. the spring element is additionally compressed and the tie rod can be easily connected or disconnected to an inlet tie rod.

To tension the tie rod, the wedge is transferred into its clamping position and the tappet carrier plate is offset in a direction opposite to the spiral tower by a stroke Δl using the spring force of the spring element 1, wherein the inlet tie rod coupled to the tie rod with a predetermined tensile stress rests tightly against the vibratable anchor plate assembly, i.e. is held firmly against it. The attached screw cap, preferably in the form of a rotary handle at the end of the outlet tie rod, ensures that this tensile stress is also transferred to the spiral modules and that the vibration stability of the entire spiral tower is guaranteed even during vibrating operation.

The electronic control unit used to displace the wedge has in particular mounting preparation software, release software and dismounting preparation software to transfer the wedge to the desired position using the stepper motor and to control the semiautomatic operation of the spiral-tightening device. To do this, the following steps are carried out using the control unit.

Before manually mounting the spiral, a) the operator switches on the main switch of the vibrating conveyor with step a1) to start the switch-on software. This switch-on software works while the anchor plate of the spiral-tightening device is not yet activated, i.e. not vibrating. In step a2), it is automatically checked whether the wedge of the spiral-tightening device is in its mounting position, and it is decided that if this is the case, step a3) will be carried out and if this is not the case, then step a4) will be carried out. In step a3), a displacement of the wedge in the direction of the mounting position is initialized and executed until a first proximity switch indicates the value=0, and then a displacement of the same in the opposite direction is carried out until this first proximity switch indicates the value=1. If this is not the case, i.e. for step a4), a displacement of the wedge in the direction of the mounting position is initialized and executed until the first proximity switch indicates a value=1. After step a3) or step a4), step a5) can begin, i.e. the spiral tower can be mounted manually.

After the spiral tower is mounted manually, i.e. after the final attachment of the rotary handle and the drive release b), the drive of the vibrating conveyor can be started using the control unit and the following steps. In a first step b1), a start button displayed on the control unit by means of a graphical user interface (GUI) is pressed manually to activate the release software. This triggers step b2), which initializes and executes a displacement of the wedge to a clamping position until a second proximity switch indicates the value=1. In step b3), it is checked whether the wedge of the spiral-tightening device is in its clamping position, and it is decided that if this is the case, step b4) will be carried out, or if this is not the case, step b4) will be carried out. With step b4), the drive of the spiral tower of the vibrating conveyor is started it begins to vibrate. In step b5), an error message (“spiral tower not tightened”) is displayed on the GUI and manual troubleshooting must be carried out in the next step b6) before step b2) can be carried out again.

Before dismounting the spiral c), the following steps are carried out. With step c1), a GUI stop button displayed on the control unit's screen is manually pressed, which stops the vibrating conveyor from vibrating and activates software to dismount the spiral tower. Said software activates a displacement of the wedge to the mounting position with a step c2) until the first proximity switch indicates the value=1. With a step c3), it is checked whether the wedge is in its mounting position. If this is the case, the spiral tower of the vibrating conveyor can be dismounted manually with step c4).

If this is not the case, an error message (“spiral tower still tightened”) is displayed on a GUI button in step c5). With step c6), manual troubleshooting is carried out to then repeat step c2).

It is understood that the required software can be provided by the person skilled in the art in the light of the stated tasks without having to be inventive.

During the mounting process, the spiral tower can be quickly and safely mounted in the desired length, i.e. in particular with a height of significantly more than approx. 2.5 m. In particular, the present invention allows generally for fast and safe mounting and adjusting of the vibratory behavior of a modularly constructed vibrating conveyor with a modular spiral tower, a modular tie rod, a vibratable drive, and a wedge slider described in more detail below. During the mounting process, the outlet spiral is preferably tightened to a defined stop by means of an ergonomically shaped rotary handle on the outlet tie rod. Only a small torque is necessary, which can be applied manually without much effort, i.e. without tools.

With the electronic control unit and by means of the wedge, the stepper motor and the proximity switches, the spiral tower can be automatically clamped with the desired clamping force within 10 seconds.

In this case, the term “vibrating conveyor” is used to describe a vibrating spiral conveyor (also called spiral conveyor) for the vertical conveying and processing of piece goods.

In a preferred embodiment of the present spiral-tightening device, the beveled surface of the wedge has an inclination of 2°to 4°.

In a further embodiment of the present spiral-tightening device, the wedge assembly is provided with a cover to catch the dust generated during operation of the vibrating conveyor.

In a particular embodiment of the present spiral-tightening device, the electronic control unit is structured in such a way that, as already explained, it executes a mounting preparation software (a), a release software (b) and a dismounting preparation software (c) independently of one another for the semiautomatic operation of the spiral-tightening device.

The invention will be explained in greater detail below in reference to an exemplary embodiment and with the help of the figures. Shown are:

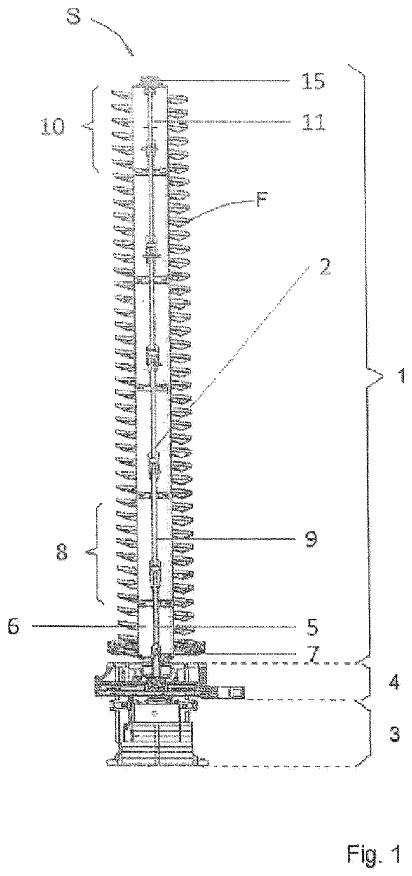

FIG. 1: a schematic representation of a preferred embodiment of a spiral tower according to the invention;

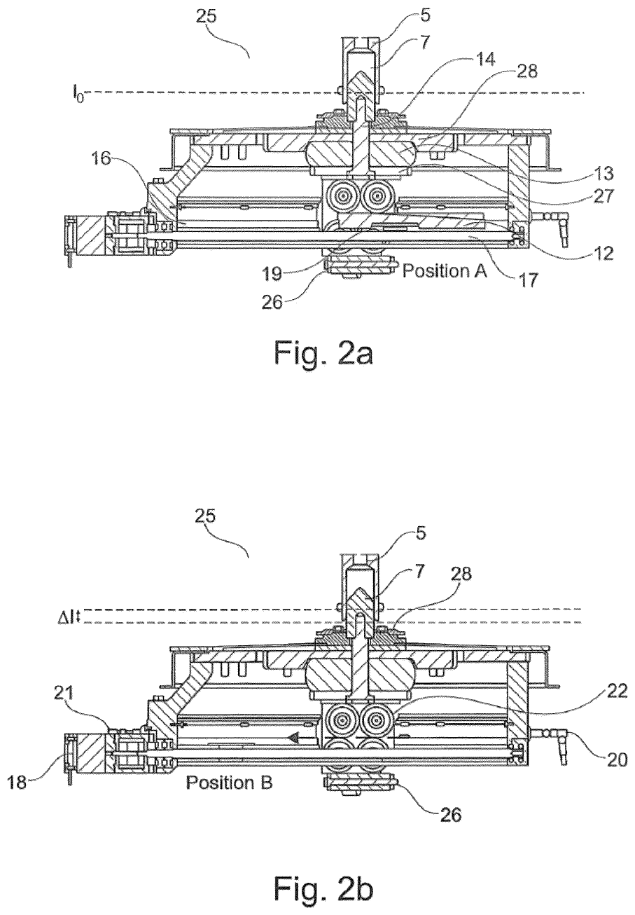

FIG. 2a: a schematic representation of a preferred embodiment of a wedge slider according to the invention in its mounting position;

FIG. 2b: a schematic representation of a preferred embodiment of a wedge slider according to the invention in its clamping position;

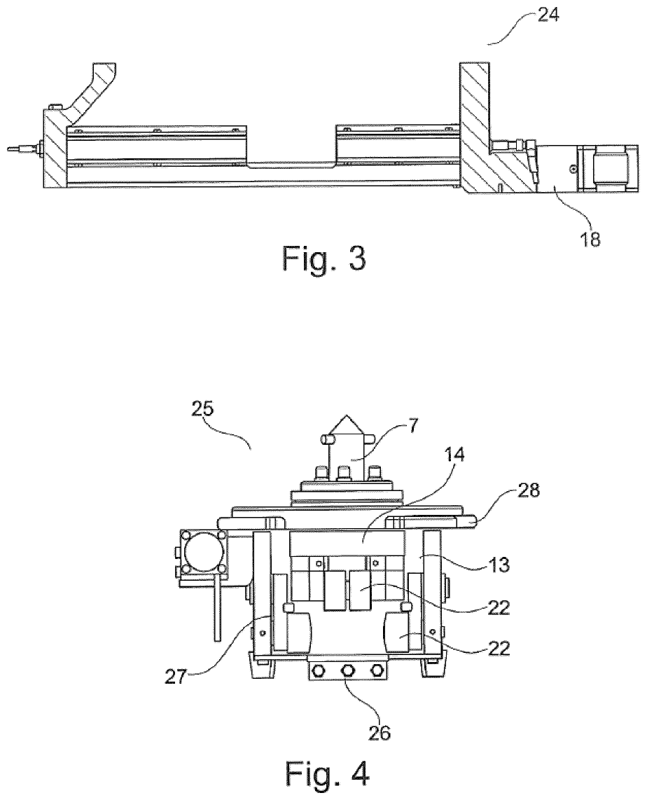

FIG. 3: a schematic representation of a decoupled “resting”wedge assembly;

FIG. 4: a schematic representation of a side view of a wedge slider according to the invention;

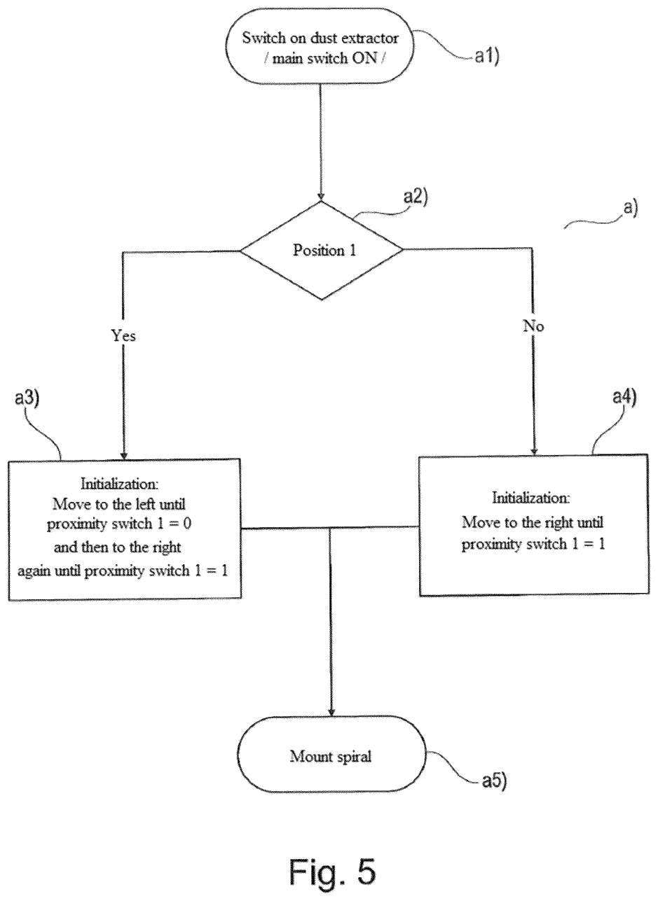

FIG. 5: a flowchart illustrating the process of switching on a vibrating conveyor according to the invention;

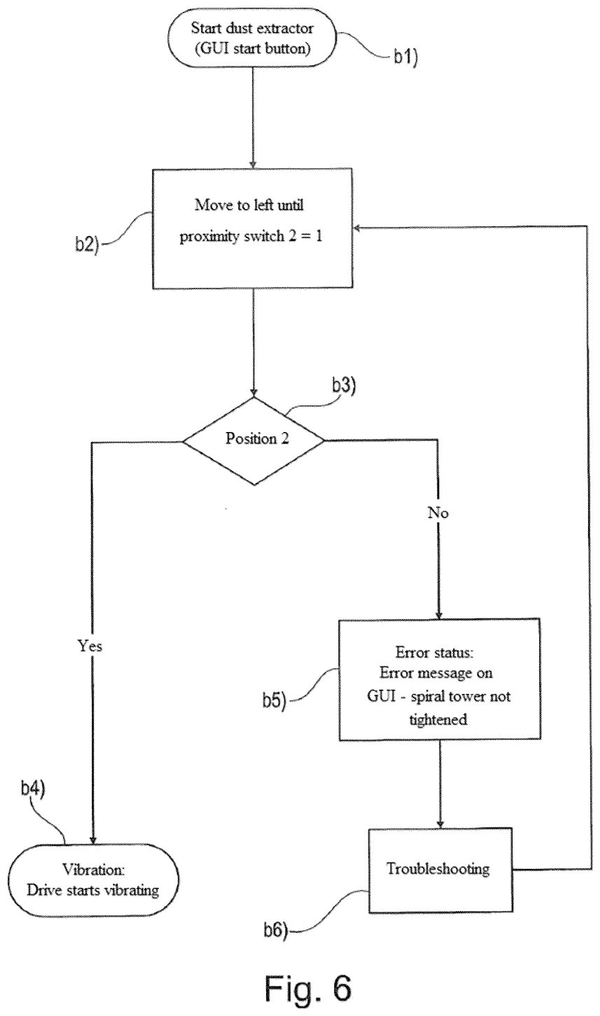

FIG. 6: a flowchart illustrating the process of starting a vibrating conveyor according to the invention;

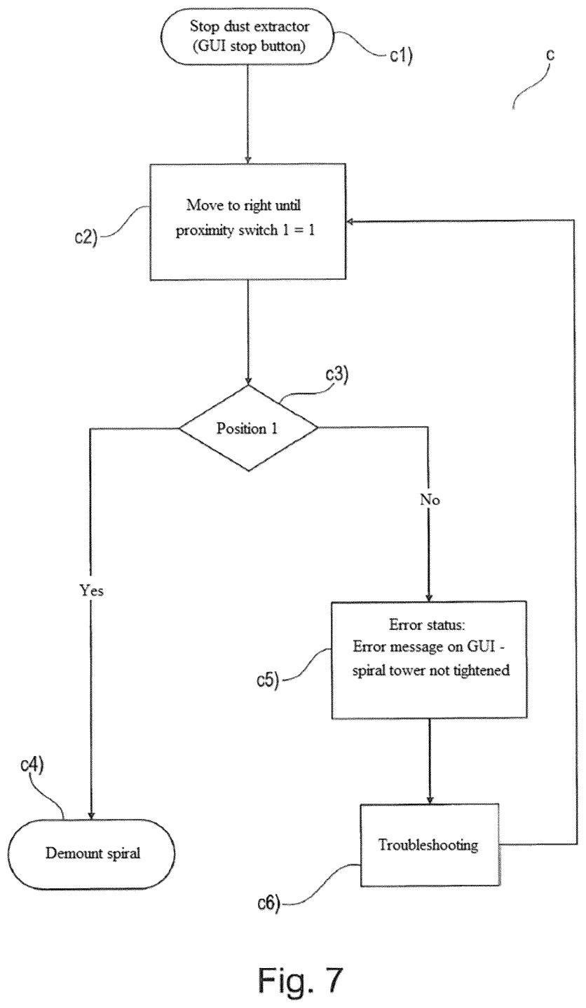

FIG. 7: a flowchart illustrating the process of stopping a vibrating conveyor according to the invention;

The vibrating conveyor (S) shown in FIG. 1 essentially comprises three components, namely a drive (3), a spiral tower (1) with a conveyor track (F) and a wedge slider (4) arranged between them, wherein this drive (3) is preferably an electromagnetic drive and the spiral tower (1) is constructed from a plurality of spiral modules (6, 8, 10). Said spiral tower (1) can have a height of more than 2.5 m and is held in a known manner by a modular tie rod (2), i.e. consisting of several tie rod modules (5, 9, 11) connected to one another by means of a bayonet lock. In this case, an inlet tie rod (5) associated with an inlet spiral (6) is connected to a tie rod (7) and an outlet tie rod (11) associated with an outlet spiral (10) is screwed to a screw cap, in particular a rotary handle (15) at its end opposite the anchor plate (26) of the drive (3).

The drive (3) is preferably an electromagnetic drive, as is well known for such vibrating conveyors (S) and, during operation, causes an anchor plate (26) and the associated tie rod (7) to vibrate, wherein the tie rod (7) is mounted so as to be vertically displaceable for fastening the inlet tie rod (5) and the other tie rod modules (9, 11), as well as the associated spiral modules (6, 8, 10). For this purpose, the wedge slider (4) has a substantially horizontally displaceable wedge (12).

FIGS. 2a and 2b show the structure of the wedge slider (4) according to the invention and illustrate its mode of operation. In particular, the wedge slider (4) for the displacement of the wedge (12) comprises a wedge assembly (24) decoupled from the drive (3) and an anchor plate assembly (25) coupled to the drive (3), i.e. vibratable. This two-part structure allows the vibratory behavior of the spiral tower to be reproducibly controlled.

In FIG. 2a, said wedge slider (4) is shown in a first position, or mounting position (A), in which the wedge (12) lies between several support rollers (22′) and several guide rollers (22) and a tappet (14), or the tie rod (7) fastened thereto, is offset in a vertical direction. The wedge assembly (24) uncoupled from the drive (3) for the displacement of the wedge (12) has a stepper motor (18) that can be activated by means of an electronic control unit (not shown) which is coupled to a threaded spindle (17), wherein a threaded nut (19) connected to the displaceable wedge (12) is mounted on said threaded spindle (17). Preferably, the wedge (12) is displaceable along a slide bar (16) arranged parallel to this threaded spindle (17).

In FIG. 2b, the wedge (12) of this wedge slider (4) is in a second position, or clamping position (B), in which the wedge (12) is uncoupled from the vibratable anchor plate assembly (25), i.e. lies completely within the wedge assembly (24) uncoupled from the drive (3). The displacement of the wedge (12) takes place in an analogous manner using the threaded spindle (17) and by means of the stepper motor (18), which can be controlled by the electronic control unit (not shown). For controlling the stepper motor (18), the spiral-tightening device has a first proximity switch (20) arranged near the mounting position (A) of the wedge (12) and a second proximity switch (21) arranged near the clamping position (B) of the wedge (12), which are electronically connected to the electronic control unit (not shown).

From FIGS. 2a and 2b, it can be seen that the anchor plate assembly (25) coupled to the drive (3) comprises an anchor plate (26) connected to a tappet carrier plate (27) that is spaced apart therefrom and displaceable. A tappet (14) is fastened to this tappet carrier plate (27), said tappet being guided in a tappet guide plate (28) so that it can be displaced essentially vertically and is firmly connected to the tie rod (7) in such a way that the tappet (14), the tappet guide plate (28) and the tappet carrier plate (27) are coupled to the anchor plate (26) in a vibration-transmitting manner.

Preferably, a spring element (13) with a predefined spring force is fitted between the tappet carrier plate (27) and the tappet guide plate (28), by means of which spring force, in particular, even several guide rollers (22) that are firmly connected to the tappet carrier plate (27) rest resiliently against a beveled surface of the wedge (12), in particular when the wedge (12) is displaced. In the mounting position (A) of the wedge (12), the tappet carrier plate (27) with the tappet (14) is offset against the specified spring force of the spring element (13) in the direction of the spiral tower (1), i.e. the spring element (13) is additionally compressed and the tie rod (7) can be easily connected or disconnected to an inlet tie rod (5). In the clamping position (B) of the wedge (12), the tappet carrier plate (27) is offset by a stroke Δl in a direction opposite to the spiral tower (1) using the spring force of the spring element (13), wherein the inlet tie rod (5) coupled to the tie rod (7) and the other tie rod modules (9, 11) attached thereto are held tightly against the vibratable anchor plate assembly (25) with predetermined tensile stress.

In this preferred embodiment of the spiral tightening device according to the invention, in the mounting position (A), as shown in FIG. 2a, the spring element (13) fitted between the tappet carrier plate (27) and the tappet guide plate (28) is compressed and the tappet (14) is offset in the direction of the spiral tower (1) in such a way that the inlet tie rod (5) can be manually attached to the tie rod (7). In contrast, the wedge slider (4), as shown in FIG. 2b, is in a second position, or clamping position (B), in which the wedge (12) is no longer located between the support rollers (22′) and the guide rollers (22) and the spring element (13) transfers its intended spring force to the tie rod (7).

The wedge (12) preferably has a bevel of 2.8°and moves along a slide bar (16). By means of the threaded spindle (17), which can be driven by a stepper motor (18) and drives a threaded nut (19) fastened to the wedge (12), the wedge (12) can be moved from the mounting position (A) to the clamping position (B). As a result, the spring element (13) is relaxed in a predetermined manner and the tie rod (7) with the tappet (14) is pulled by this spring element (13) with a defined stroke Δl in the direction of the anchor plate (26). This means that the spiral tower (1) can be tensioned automatically with the predetermined tension within 10 seconds. This always happens before the vibrating conveyor is started and the anchor plate (26) begins to vibrate. The stepper motor (18) for the threaded spindle (17) is controlled by means of a motor controller and a software program developed specifically for this purpose. The monitoring of the mounting position (A), i.e. the correct positioning of the wedge (12) in this position (A), is ensured by means of a first proximity switch (20), while the monitoring of the clamping position (B), or the correct positioning of the wedge (12) in this position (B), is ensured by means of a second proximity switch (21). The guide rollers (22) and support rollers (22′) on the top and bottom of the wedge ensure optimal guidance of the electronically controlled displaceable wedge (12) when changing position. Advantageously, the wedge slider (4) is protected by a cover (23, not shown).

FIG. 3 shows the wedge assembly (24) resting in the uncoupled state of the drive (3, not shown), which is connected to a stepper motor that can be controlled by an electronic control unit (not shown) to displace the wedge (not shown). In this case, this wedge assembly is also called a decoupled wedge assembly.

The side view of the wedge slide valve (4) according to the invention shown in FIG. 4 shows the anchor plate assembly (25) coupled to the drive, which comprises the anchor plate (26, not shown) and which is firmly connected to a tappet carrier plate spaced therefrom. The tappet provided for coupling the inlet tie rod (5) is fastened to the tie rod (7) on this tappet carrier plate, whereby the tappet is displaceably guided in a tappet guide plate. This tappet guide plate with the spaced apart tappet carrier plate and the anchor plate firmly connected to it are coupled to each other in a vibration-transmitting manner. The spring element (13) is fitted between the tappet carrier plate and the at least one tappet guide plate with a predefined spring force, said spring element interacting with the tappet carrier plate, wherein this tappet carrier plate is firmly connected to several guide rollers (22), said guide rollers (22) resting resiliently against the beveled surface of the wedge (12) when it is displaced. The wedge (12) moves when displaced between the support rollers (22′) and the guide rollers (22).

If the wedge (12) is in the mounting position (A), the tappet carrier plate with the tappet (14) is displaced against the spring force of the spring element (13) in the direction of the spiral tower (1) and the tie rod (7) can be easily connected to an inlet tie rod (5). If the wedge (12) is in the clamping position (B), the tappet carrier plate is displaced in the direction opposite to the spiral tower (1) by means of the spring force of the spring element (13) in order to fasten the inlet tie rod (5) provided with the tie rod (7) and the tie rod modules (9) attached thereto to the vibratable anchor plate assembly (25) with a predetermined tensile stress.

The control process for switching on the vibrating conveyor according to the invention is shown in FIG. 5. As already described, a) the following steps are carried out before the spiral is mounted manually. First, the operator responsible switches on the main switch of the vibrating conveyor (S) with step a1) in order to start a switch-on software. This switch-on software works while the anchor plate of the spiral-tightening device is not yet activated, i.e. not vibrating. With step a2), it is automatically checked whether the wedge (12) of the spiral-tightening device is in its mounting position (A), and it is decided that if this is the case, step a3) will be carried out and if this is not the case, then step a4) will be carried out. In step a3), a displacement of the wedge (12) in the direction of the mounting position (A) is initialized and executed until a first proximity switch indicates the value=0, and then a displacement of the wedge (12) in the opposite direction is carried out until this first proximity switch indicates the value=1. If this is not the case, i.e. for step a4), a displacement of the wedge in the direction of the mounting position is initialized and executed until the first proximity switch indicates a value=1. After step a3) or step a4), step a5) can begin, i.e. the spiral tower can be mounted manually.

FIG. 6 schematically shows the process when starting the vibrating conveyor according to the invention, wherein b) to release the drive, the vibrating conveyor drive can be started using the control unit as follows. In a first step b1), a start button displayed on the control unit by means of a graphical user interface (GUI) is pressed to activate the release software. This triggers step b2), which initializes and executes a displacement of the wedge to a clamping position until a second proximity switch indicates the value=1. In a step b2), it is checked whether the wedge of the spiral-tightening device is in its clamping position, and it is decided that if this is the case, step b4) will be carried out, and if f this is not the case, step b5) is carried out. With step b4), the drive of the spiral tower of the vibrating conveyor is started and it begins to vibrate. In step b5), an error message (“spiral tower not tightened”) is displayed on the GUI and manual error correction must be carried out in the next step b6) before step b2) can be carried out again.

FIG. 7 shows the process of stopping the vibrating conveyor (S) according to the invention, in which c) before dismounting the spiral with step c1), a GUI stop button shown on a display of the control unit is pressed, in order to stop the vibration of the spiral tower (1) of the vibrating conveyor (S), and a software for dismounting the spiral is activated. Said software activates a displacement of the wedge to the mounting position (A) with a step c2) until the first proximity switch indicates the value=1. With a step c3), it is checked whether the wedge is in its mounting position (A). If this is the case, the spiral tower (1) of the vibrating conveyor (S) can be dismounted manually with step c4). If this is not the case, an error message (“spiral tower still tightened”) is displayed on a GUI button in step c5). With step c6), manual troubleshooting is carried out to then repeat step c2).

It is understood that the use of the spiral-tightening device according to the invention and the associated method for controlling the operation thereof enables the construction of vibrating conveyors with a conveying height of more than approximately 2.5 m, in particular from approximately 2.5 m up to approximately 5 m, without being limited thereto.

1-17. (canceled)

18: A spiral-tightening device for a tie rod of a spiral tower of a vertical vibrating conveyor, whereby the spiral tower comprises multiple spiral modules and is secured with a screw cap, the spiral-tightening device comprising:
an anchor plate configured to be set into vibration by means of an electromagnetic drive; and
a tie anchor connectable to an inlet tie rod;
wherein the spiral-tightening device has a wedge slider arranged between the spiral tower and the drive,
wherein the wedge slider comprises a wedge assembly decoupled from the drive for mounting or dismounting the spiral tower and an anchor plate assembly coupled to the drive, which is vibratable for vibrating the spiral tower; and
wherein the spiral-tightening device comprises a displaceable wedge which is substantially displaceable horizontally between a mounting position and a clamping position by means of which the tie anchor connectable to the inlet tie rod is substantially shiftable vertically for clamping the tie rod.

19: The spiral-tightening device of claim 18, wherein the wedge assembly decoupled from the drive for the displacement of the wedge has a stepper motor that is activatable by means of an electronic control unit and is coupled to a threaded spindle on which a threaded nut connected to the displaceable wedge is mounted.

20: The spiral-tightening device of claim 19, wherein the wedge is displaceable along a slide bar by means of said threaded spindle.

21: The spiral-tightening device of claim 18, wherein the spiral-tightening device has a first proximity switch arranged near the mounting position of the wedge and a second proximity switch arranged near the clamping position of the wedge, said first and second proximity switches being electronically connected to the electronic control unit for controlling the stepper motor.

22: The spiral-tightening device of claim 18, wherein the anchor plate assembly coupled to the drive comprises an anchor plate, which is connected to a tappet carrier plate that is spaced apart and is displaceable, to which tappet carrier plate a tappet that is guided vertically displaceably in a tappet guide plate and firmly connected to the tie anchor is fastened, such that said tappet, the tappet guide plate and the tappet carrier plate are coupled to the anchor plate in a vibration-transmitting manner.

23: The spiral-tightening device of claim 22, wherein a spring element with a predefined spring force is fitted between the tappet carrier plate and the tappet guide plate.

24: The spiral-tightening device of claim 23, wherein multiple guide rollers are firmly connected to said tappet carrier plate, which guide rollers rest resiliently on a beveled surface of the wedge when it is displaced.

25: The spiral-tightening device of claim 24, wherein, in the mounting position of the wedge, the tappet carrier plate with the tappet is offset against the specified spring force of the spring element in the direction of the spiral tower such that the spring element is additionally compressed and the tie anchor is connectable or disconnectable to the inlet tie rod.

26: The spiral-tightening device of claim 24, wherein, in the clamping position of the wedge, the tappet carrier plate is offset by a stroke in a direction opposite to the spiral tower using the spring force of the spring element, wherein the inlet tie rod coupled to the tie anchor and an additional tie rod module attached thereto are held against the vibratable anchor plate assembly with predetermined tensile stress.

27: The spiral-tightening device of claim 24, wherein the beveled surface of the wedge has an inclination of 2°to 4°.

28: The spiral-tightening device of claim 18, wherein the electronic control unit has a mounting preparation software, a release software and a dismounting preparation software.

29: The spiral-tightening device of claim 18, wherein the wedge assembly has a cover.

30: A method for controlling the semiautomatic operation of a spiral-tightening device of claim 18, said method
comprising the following steps before manually mounting the spiral:
step a1): manually switching on a main switch of the vibrating conveyor to start a switch-on software which runs when the anchor plate of the spiral-tightening device is not yet activated and is not vibrating;
step a2): checking whether the wedge of the spiral-tightening device is in its mounting position and
if yes, then:
step a3): initializing a displacement of the wedge until a first proximity switch indicates the value=0 and then displacement of the same in the opposite direction until this first proximity switch indicates the value=1, and
if not, then:
step a4): initializing a displacement of the wedge until the first proximity switch indicates a value=1; and
step a5): after step a3) or step a4), manually mounting the spiral tower.

31: The method for controlling the semiautomatic operation of a spiral-tightening device of claim 18, said method
comprising the following steps for drive release:
step b1): pressing a GUI start button, which activates a release software;
step b2): initializing a displacement of the wedge into a clamping position until a second proximity switch indicates the value=1;
step b3): checking whether the wedge of the spiral-tightening device is in its clamping position and
if yes, then:
step b4): releasing the drive for vibrating the spiral tower of the vibrating conveyor; and
if not, then:
step b5): displaying an error message on the GUI start button; and
step b6): manual troubleshooting and repeating step b2).

32: The method for controlling the semiautomatic operation of a spiral-tightening device of claim 18, said method
comprising the following steps before dismounting the spiral:
step c1): pressing a GUI stop button, which stops the vibration of the spiral tower of the vibrating conveyor and activates a software for dismounting the spiral;
step c2): initiating a displacement of the wedge into the mounting position until the first proximity switch indicates the value=1;
step c3): checking whether the wedge is in its mounting position, and
if yes, then:
step c4): manual dismounting the spiral tower of the vibrating conveyor; and
if not, then:
step c5): displaying an error message on the GUI start button; and
step c6): manual troubleshooting and repeating step c2).

33: A combination of a spiral tightening device of claim 18, with a vertical vibrating conveyor comprising a plurality of spiral modules, which
(i) is secured with a screw cap; and
(ii) has a tie rod,
wherein the vibratory conveyor has a conveying height of more than 2.5 m.

34: The combination of claim 33, wherein the screw cap is a manually operable rotary handle.
